(19) United States
(12) Patent Application Publication
(10) Pub. No.: US 2015/0121250 A1
(43) Pub. Date: Apr. 30, 2015

(54) PROVIDING INTELLIGENT MANAGEMENT FOR WEB REAL-TIME COMMUNICATIONS (WebRTC) INTERACTIVE FLOWS, AND RELATED METHODS, SYSTEMS, AND COMPUTER-READABLE MEDIA

(71) Applicant: Avaya Inc., Basking Ridge, NJ (US)

(72) Inventors: Harvey S. Waxman, Holmdel, NJ (US); John H. Yoakum, Cary, NC (US); Kundan Singh, San Francisco, CA (US)

(73) Assignee: Avaya Inc., Basking Ridge, NJ (US)

(21) Appl. No.: 14/068,943

(22) Filed: Oct. 31, 2013

(51) Int. Cl. H04L 29/06; G06F 3/0482; G06F 3/0486; G06F 3/0481; G06F 3/0484

(52) U.S. Cl. CPC H04L 65/403; G06F 3/04817; G06F 3/04842; G06F 3/0486; G06F 3/0482
USPC 715/753

(57) ABSTRACT

Intelligently managing Web Real-Time Communications (WebRTC) interactive flows, and related systems, methods, and computer-readable media are disclosed herein. In one embodiment, a system for intelligently managing WebRTC interactive flows comprises at least one communications interface, and an associated computing device comprising a WebRTC client. The WebRTC client is configured to receive a user input gesture directed to one or more visual representations corresponding to one or more WebRTC users, and determine a context for the WebRTC client based on a current state of the WebRTC client. The WebRTC client is further configured to obtain one or more identity attributes associated with the one or more WebRTC users, and provide one or more WebRTC interactive flows including the one or more WebRTC users based on the context, the user input gesture, and the one or more identity attributes.

### BACKGROUND

1. Field of the Disclosure

The technology of the disclosure relates generally to Web Real-Time Communications (WebRTC) interactive flows.

2. Technical Background

Web Real-Time Communications (WebRTC) is an ongoing effort to develop industry standards for integrating real-time communications functionality into web clients, such as web browsers, to enable direct interaction with other web clients. This real-time communications functionality is accessible by web developers via standard markup tags, such as those provided by version 5 of the Hypertext Markup Language (HTML5), and client-side scripting Application Programming Interfaces (APIs) such as JavaScript APIs. More information regarding WebRTC may be found in “WebRTC: APIs and RTCWEB Protocols of the HTML5 Real-Time Web,” by Alan B. Johnston and Daniel C. Burnett, 2^{nd} Edition (2013 Digital Codex LLC), which is incorporated in its entirety herein by reference.

WebRTC provides built-in capabilities for establishing real-time video, audio, and/or data flows in both point-to-point interactive sessions and multi-party interactive sessions. The WebRTC standards are currently under joint development by the World Wide Web Consortium (W3C) and the Internet Engineering Task Force (IETF). Information on the current state of WebRTC standards can be found at, e.g., http://www.w3c.org and http://www.ietf.org.

To establish a WebRTC interactive flow (e.g., a real-time video, audio, and/or data exchange), two WebRTC clients may retrieve WebRTC-enabled web applications, such as HTML5/JavaScript web applications, from a web application server. Through the web applications, the two WebRTC clients then engage in dialogue for initiating a peer connection over which the WebRTC interactive flow will pass. The initiation dialogue may include a media negotiation to communicate and reach an agreement on parameters that define characteristics of the WebRTC interactive flow. Once the initiation dialogue is complete, the WebRTC clients may then establish a direct peer connection with one another, and may begin an exchange of media and/or data packets transporting real-time communications. The peer connection between the WebRTC clients typically employs the Secure Real-time Transport Protocol (SRTP) to transport real-time media flows, and may utilize various other protocols for real-time data interchange. While direct peer connections between or among the WebRTC clients is typical, other topologies, such as those including a common media server to which each WebRTC client is directly connected, may be employed.

Typical web clients that provide WebRTC functionality (such as WebRTC-enabled web browsers) have evolved to primarily support textual and data-driven interactions. As such, the behavior of existing WebRTC clients in response to user input gestures such as drag-and-drop input may not be well defined in the context of WebRTC interactive flows. This may especially be the case where multiple users are participating in WebRTC interactive sessions and/or multiple instances of a WebRTC client are active simultaneously.

### SUMMARY OF THE DETAILED DESCRIPTION

Embodiments disclosed in the detailed description provide intelligent management for Web Real-Time Communications (WebRTC) interactive flows. Related methods, systems, and computer-readable media are also disclosed. In this regard, in one embodiment, a system for intelligently managing WebRTC interactive flows is provided. The system includes at least one communications interface, and a computing device associated with the at least one communications interface. The computing device comprises a WebRTC client that is configured to receive a user input gesture directed to one or more visual representations corresponding to one or more WebRTC users. The WebRTC client is further configured to determine a context for the WebRTC client based on a current state of the WebRTC client. The WebRTC client is additionally configured to obtain one or more identity attributes associated with the one or more WebRTC users. The WebRTC client is also configured to provide one or more WebRTC interactive flows including the one or more WebRTC users based on the context, the user input gesture, and the one or more identity attributes.

In another embodiment, a method for intelligently managing WebRTC interactive flows is provided. The method comprises receiving, by a WebRTC client executing on a computing device, a user input gesture directed to one or more visual representations corresponding to one or more WebRTC users. The method further comprises determining, by the WebRTC client, a context for the WebRTC client based on a current state of the WebRTC client. The method additionally comprises obtaining one or more identity attributes associated with the one or more WebRTC users. The method also comprises providing one or more WebRTC interactive flows including the one or more WebRTC users based on the context, the user input gesture, and the one or more identity attributes.

In another embodiment, a non-transitory computer-readable medium is provided, having stored thereon computer-executable instructions to cause a processor to implement a method for intelligently managing WebRTC interactive flows. The method implemented by the computer-executable instructions comprises receiving a user input gesture directed to one or more visual representations corresponding to one or more WebRTC users. The method implemented by the computer-executable instructions further comprises determining a context for the WebRTC client based on a current state of the WebRTC client. The method implemented by the computer-executable instructions additionally comprises obtaining one or more identity attributes associated with the one or more WebRTC users. The method implemented by the computer-executable instructions also comprises providing one or more WebRTC interactive flows including the one or more WebRTC users based on the context, the user input gesture, and the one or more identity attributes.

### BRIEF DESCRIPTION OF THE FIGURES

The accompanying drawing figures incorporated in and forming a part of this specification illustrate several aspects of the disclosure, and together with the description serve to explain the principles of the disclosure.

FIG. 1 is a conceptual diagram illustrating an exemplary interactive communications system including a Web Real-Time Communications (WebRTC) client for intelligently managing WebRTC interactive flows;

FIG. 2 is a flowchart illustrating exemplary operations for intelligent management for WebRTC interactive flows by the WebRTC client of FIG. 1;

FIGS. 3A and 3B are diagrams illustrating a participant of a WebRTC interactive session in a first instance of the WebRTC client of FIG. 1 being added into an existing WebRTC interactive session in a second instance of the WebRTC client using a drag-and-drop user input gesture;

FIG. 4 is a flowchart illustrating exemplary operations for adding a participant of a WebRTC interactive session in a first instance of the WebRTC client of FIG. 1 into an existing WebRTC interactive session in a second instance of the WebRTC client using a drag-and-drop user input gesture;

FIGS. 5A and 5B are diagrams illustrating a participant of a WebRTC interactive session in a first instance of the WebRTC client of FIG. 1 being added into a new WebRTC interactive session in a second instance of the WebRTC client using a drag-and-drop user input gesture;

FIG. 6 is a flowchart illustrating exemplary operations for adding a participant of a WebRTC interactive session in a first instance of the WebRTC client of FIG. 1 into a new WebRTC interactive session in a second instance of the WebRTC client using a drag-and-drop user input gesture;

FIGS. 7A and 7B are diagrams illustrating a user being added to a WebRTC interactive session in an instance of the WebRTC client of FIG. 1 using a visual representation of the user associated with an application not participating in an active WebRTC exchange;

FIG. 8 is a flowchart illustrating exemplary operations for adding a user to a WebRTC interactive session in an instance of the WebRTC client of FIG. 1 using a visual representation of the user associated with an application not participating in a WebRTC exchange;

FIGS. 9A and 9B are diagrams illustrating a user being added to a new WebRTC interactive session in an instance of the WebRTC client of FIG. 1 using a visual representation of a user associated with an application not participating in an active WebRTC exchange;

FIG. 10 is a flowchart illustrating exemplary operations for adding a user to a new WebRTC interactive session in an instance of the WebRTC client of FIG. 1 using a visual representation of a user associated with an application not participating in a WebRTC exchange; and

FIG. 11 is a block diagram of an exemplary processor-based system that may include the WebRTC client of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide intelligent management for Web Real-Time Communications (WebRTC) interactive flows. Related methods, systems, and computer-readable media are also disclosed. In this regard, in one embodiment, a system for intelligently managing WebRTC interactive flows is provided. The system includes at least one communications interface, and a computing device associated with the at least one communications interface. The computing device comprises a WebRTC client that is configured to receive a user input gesture directed to one or more visual representations corresponding to one or more WebRTC users. The WebRTC client is further configured to determine a context for the WebRTC client based on a current state of the WebRTC client. The WebRTC client is additionally configured to obtain one or more identity attributes associated with the one or more WebRTC users. The WebRTC client is also configured to provide one or more WebRTC interactive flows including the one or more WebRTC users based on the context, the user input gesture, and the one or more identity attributes.

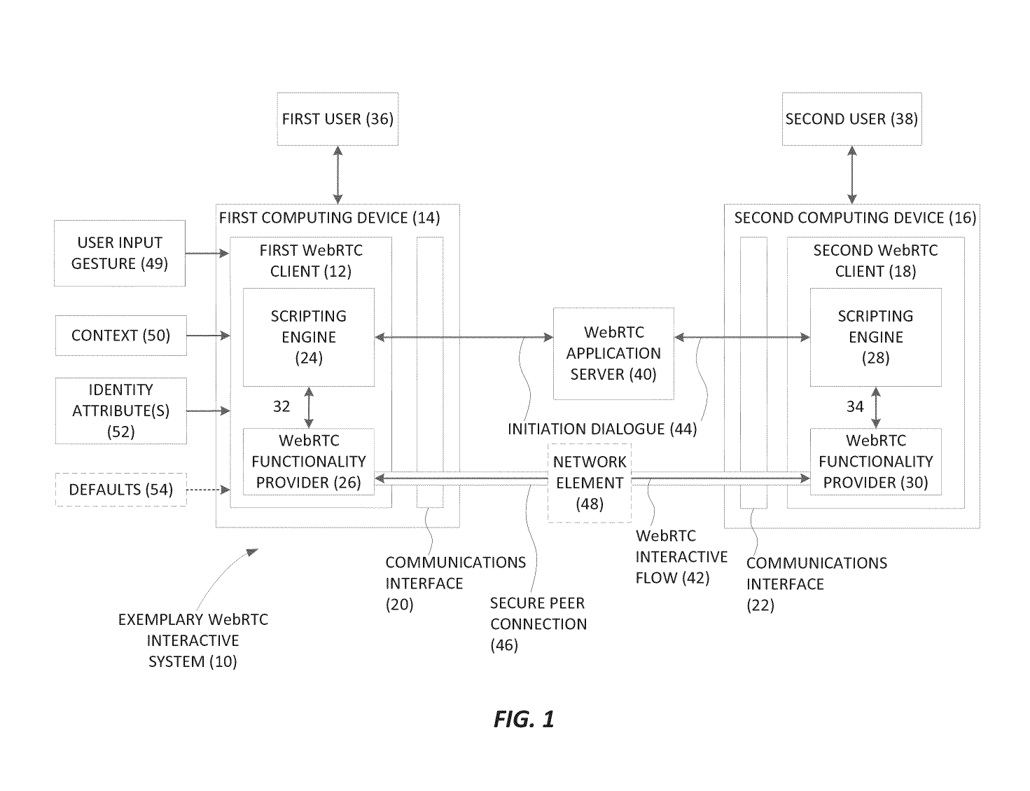

FIG. 1 shows an exemplary WebRTC interactive system 10 for intelligently managing WebRTC interactive flows as disclosed herein. In particular, the exemplary WebRTC interactive system 10 includes a WebRTC client 12 for establishing WebRTC interactive flows and providing intelligent management of the WebRTC interactive flows. As used herein, a “WebRTC interactive session” refers generally to operations for establishing peer connections or other connection topologies, and commencing WebRTC interactive flows between or among two or more endpoints. A “WebRTC interactive flow,” as disclosed herein, refers to an interactive media flow and/or an interactive data flow that passes between or among two or more endpoints according to WebRTC standards and protocols. As non-limiting examples, an interactive media flow constituting a WebRTC interactive flow may comprise a real-time audio stream and/or a real-time video stream, or other real-time media or data streams. Data and/or media comprising a WebRTC interactive flow may be collectively referred to herein as “content.”

Before discussing details of the WebRTC client 12, the establishment of a WebRTC interactive flow in the WebRTC interactive system 10 of FIG. 1 is first described. In FIG. 1, a first computing device 14 executes the first WebRTC client 12, and a second computing device 16 executes a second WebRTC client 18. It is to be understood that the computing devices 14 and 16 may both be located within a same public or private network, or may be located within separate, communicatively coupled public or private networks. Some embodiments of the WebRTC interactive system 10 of FIG. 1 may provide that each of the computing devices 14 and 16 may be any computing device having network communications capabilities, such as a smartphone, a tablet computer, a dedicated web appliance, a media server, a desktop or server computer, or a purpose-built communications device, as non-limiting examples. The computing devices 14 and 16 include communications interfaces 20 and 22 respectively, for connecting the computing devices 14 and 16 to one or more public and/or private networks. In some embodiments, the elements of the computing devices 14 and 16 may be distributed across more than one computing device 14 and 16.

The WebRTC clients 12 and 18, in this example, may each be a web browser application and/or a dedicated communications application, as non-limiting examples. The WebRTC client 12 comprises a scripting engine 24 and a WebRTC functionality provider 26. Similarly, the WebRTC client 18 comprises a scripting engine 28 and a WebRTC functionality provider 30. The scripting engines 24 and 28 enable client-side applications written in a scripting language, such as JavaScript, to be executed within the WebRTC clients 12 and 18, respectively. The scripting engines 24 and 28 also provide application programming interfaces (APIs) to facilitate communications with other functionality providers within the WebRTC clients 12 and/or 18, the computing devices 14 and/or 16, and/or with other web clients, user devices, or web servers. The WebRTC functionality provider 26 of the WebRTC client 12 and the WebRTC functionality provider 30 of the WebRTC client 18 implement the protocols, codecs, and APIs necessary to enable real-time interactive flows via WebRTC. The scripting engine 24 and the WebRTC functionality provider 26 are communicatively coupled via a set of defined APIs, as indicated by bidirectional arrow 32. Likewise, the scripting engine 28 and the WebRTC functionality provider 30 are communicatively coupled as shown by bidirectional arrow 34. The WebRTC clients 12 and 18 are configured to receive input from users 36 and 38, respectively, for establishing, participating in, and/or terminating WebRTC interactive flows.

A WebRTC application server 40 is provided for serving a WebRTC-enabled web application (not shown) to requesting WebRTC clients 12, 18. In some embodiments, the WebRTC application server 40 may be a single server, while in some applications the WebRTC application server 40 may comprise multiple servers that are communicatively coupled to each other. It is to be understood that the WebRTC application server 40 may reside within the same public or private network as the computing devices 14 and/or 16, or may be located within a separate, communicatively coupled public or private network.

FIG. 1 further illustrates the characteristic WebRTC topology that results from establishing a WebRTC interactive flow 42 between the WebRTC client 12 and the WebRTC client 18. To establish the WebRTC interactive flow 42, the WebRTC client 12 and the WebRTC client 18 both download a same WebRTC web application or compatible WebRTC web applications (not shown) from the WebRTC application server 40. In some embodiments, the WebRTC web application comprises an HTML5/JavaScript web application that provides a rich user interface using HTML5, and uses JavaScript to handle user input and to communicate with the WebRTC application server 40.

The WebRTC client 12 and the WebRTC client 18 then engage in an initiation dialogue 44, which may include any data transmitted between or among the WebRTC client 12, the WebRTC client 18, and/or the WebRTC application server 40 to establish a peer connection for the WebRTC interactive flow 42. The initiation dialogue 44 may include WebRTC session description objects, HTTP header data, certificates, cryptographic keys, and/or network routing data, as non-limiting examples. In some embodiments, the initiation dialogue 44 may comprise a WebRTC offer/answer exchange. Data exchanged during the initiation dialogue 44 may be used to determine the media types and capabilities for the desired WebRTC interactive flow 42. Once the initiation dialogue 44 is complete, the WebRTC interactive flow 42 may be established via a secure peer connection 46 between the WebRTC client 12 and the WebRTC client 18.

In some embodiments, the secure peer connection 46 may pass through a network element 48. The network element 48 may be a computing device having network communications capabilities and providing media transport and/or media processing functionality. As non-limiting examples, the network element 48 may be a Network Address Translation (NAT) server, a Session Traversal Utilities for NAT (STUN) server, a Traversal Using Relays around NAT (TURN) server, and/or a media server. It is to be understood that, while the example of FIG. 1 illustrates a peer-to-peer case, other embodiments as disclosed herein may include other network topologies. As a non-limiting example, the WebRTC client 12 and the WebRTC client 18 may be connected via a common media server such as the network element 48.

As noted above, the WebRTC clients 12 and 18 may include WebRTC-enabled web browsers, which have evolved to support textual and data-driven interactions. Accordingly, the behavior of typical WebRTC clients in response to user input gestures such as drag-and-drop input may not be well defined in the context of WebRTC interactive flows generally. This may especially be the case when more than two users are participating in a given WebRTC interactive session, and/or multiple WebRTC interactive sessions are active simultaneously within multiple instances of a WebRTC client.

Accordingly, the WebRTC client 12 of FIG. 1 is provided to intelligently manage WebRTC interactive flows. The WebRTC client 12 is configured to receive a user input gesture 49, which may be directed to one or more visual representations corresponding to one or more WebRTC users, and which may indicate a desired action to be carried out with respect to the corresponding WebRTC user(s), as discussed in greater detail below. The user input gesture 49 may be received via a mouse, touchscreen, or other input device, and may be initiated by button click, touch, or wave gesture. The user input gesture 49 may include a drag gesture, a drag-and-drop gesture, a left- or right-click operation, a multi-touch interface operation, or a menu selection, as non-limiting examples. In some embodiments, the visual representation to which the user input gesture 49 is directed may correspond specifically to a particular type of WebRTC interactive flow (e.g., a WebRTC video, audio, and/or chat interactive flow) for a WebRTC user, or may represent all available WebRTC interactive flows for a WebRTC user. The visual representation may be a static visual representation such as a text element, an icon, image, or text string (such as an email address), or may be a dynamic visual representation such as a window showing an ongoing WebRTC video or textual flow, as non-limiting examples.

The WebRTC client 12 may determine an appropriate action to take in response to the user input gesture 49 based on a context 50. The context 50 may include an awareness of a state of one or more instances of the WebRTC client 12, and/or an awareness of a state of one or more other applications executing concurrently alongside the WebRTC client 12. The WebRTC client 12 may also obtain one or more identity attributes 52 associated with one or more WebRTC users associated with the visual representation(s) to which the user input gesture 49 is directed. The identity attribute(s) 52 may be based on identity information accessible to the WebRTC client 12, or may be provided by an external application and/or an operating system on which the WebRTC client 12 is executing.

The WebRTC client 12 optionally may determine an appropriate action based on other inputs, such as defaults 54. In some embodiments, the defaults 54 may comprise administrative defaults that define behaviors or responses that will automatically be used in given situations. Defaults 54 may specify behaviors of the WebRTC client 12 generally, or may be associated with specific WebRTC users or user input gestures. The WebRTC client 12 may also determine an appropriate action based on additional contextual information such as a specific type of WebRTC interactive flow requested (e.g., audio and video, or audio only).

Based on the user input gesture 49, the context 50, the identity attribute(s) 52, and other provided inputs such as defaults 54, the WebRTC client 12 may provide one or more WebRTC interactive flows 42 including the one or more WebRTC users associated with the visual representation(s) to which the user input gesture 49 is directed. In some embodiments, providing the one or more WebRTC interactive flows 42 may include establishing a new WebRTC interactive flow 42, modifying an existing WebRTC interactive flow 42, and/or terminating an existing WebRTC interactive flow 42. In this manner, the WebRTC client 12 may provide intuitive and flexible WebRTC interactive flow management, including muting and unmuting as well as creating and merging WebRTC interactive sessions, and providing a content of, suppressing a content of, and/or muting and unmuting individual WebRTC interactive flows. It is to be understood that the functionality of the WebRTC client 12 as disclosed herein may be provided by a web application being executed by the WebRTC client 12, by a browser extension or plug-in integrated into the WebRTC client 12, and/or by native functionality of the WebRTC client 12 itself.

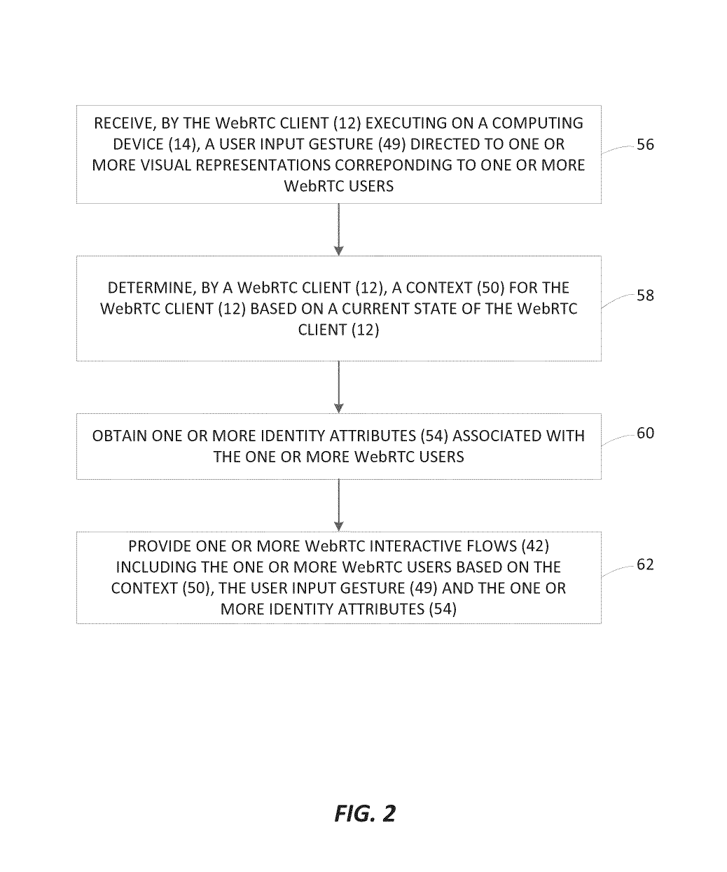

FIG. 2 is a flowchart illustrating exemplary operations for intelligent management for WebRTC interactive flows by the WebRTC client 12 of FIG. 1. For the sake of clarity, elements of FIG. 1 are referenced in describing FIG. 2. In FIG. 2, operations commence with the WebRTC client 12 executing on the computing device 14 receiving a user input gesture 49 directed to one or more visual representations corresponding to one or more WebRTC users (block 56). Some embodiments may provide that the user input gesture 49 comprises a drag-and-drop gesture, a button click, a touch, a wave, and/or a menu selection as non-limiting examples. The WebRTC client 12 next determines a context 50 for the WebRTC client 12 based on a current state of the WebRTC client 12 (block 58). In some embodiments, the context 50 may include an awareness of a state of one or more instances of the WebRTC client 12, and/or an awareness of a state of one or more other applications executing concurrently with the WebRTC client 12.

The WebRTC client obtains one or more identity attributes 52 associated with the one or more WebRTC users (block 60). The identity attribute(s) 52 may be based on identity information accessible to the WebRTC client, or may be provided by an external application and/or an operating system on which the WebRTC client is executing. The WebRTC client then provides one or more WebRTC interactive flows 42 including the one or more WebRTC users based on the context 50, the user input gesture 49, and the one or more identity attributes 52 (block 62).

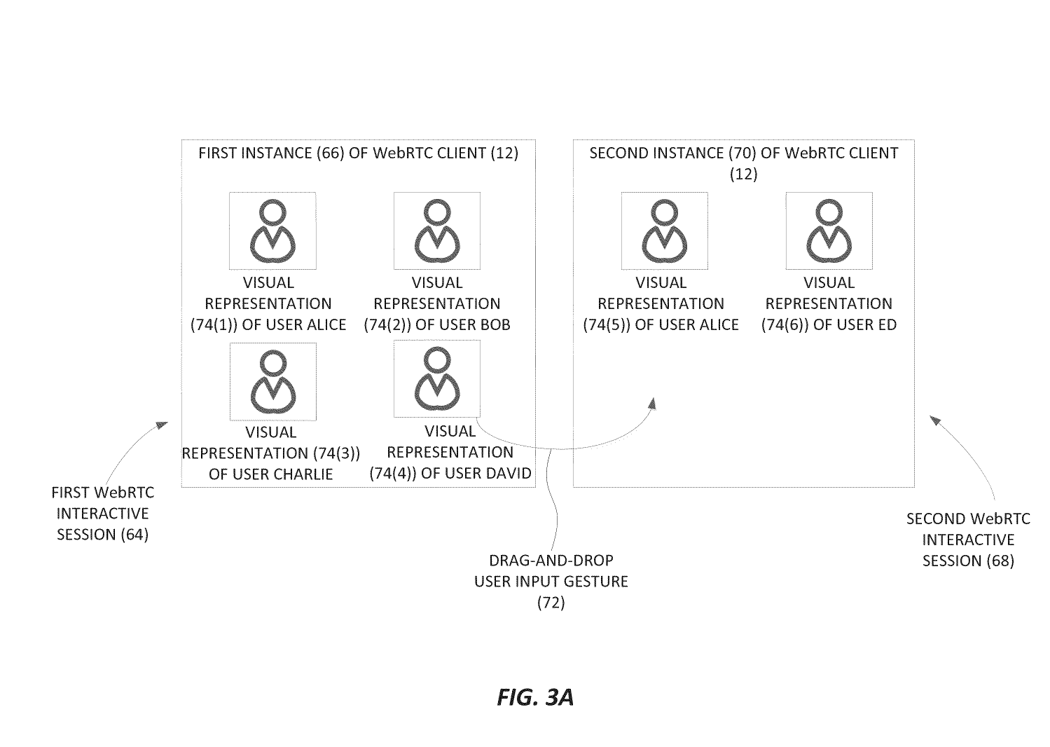

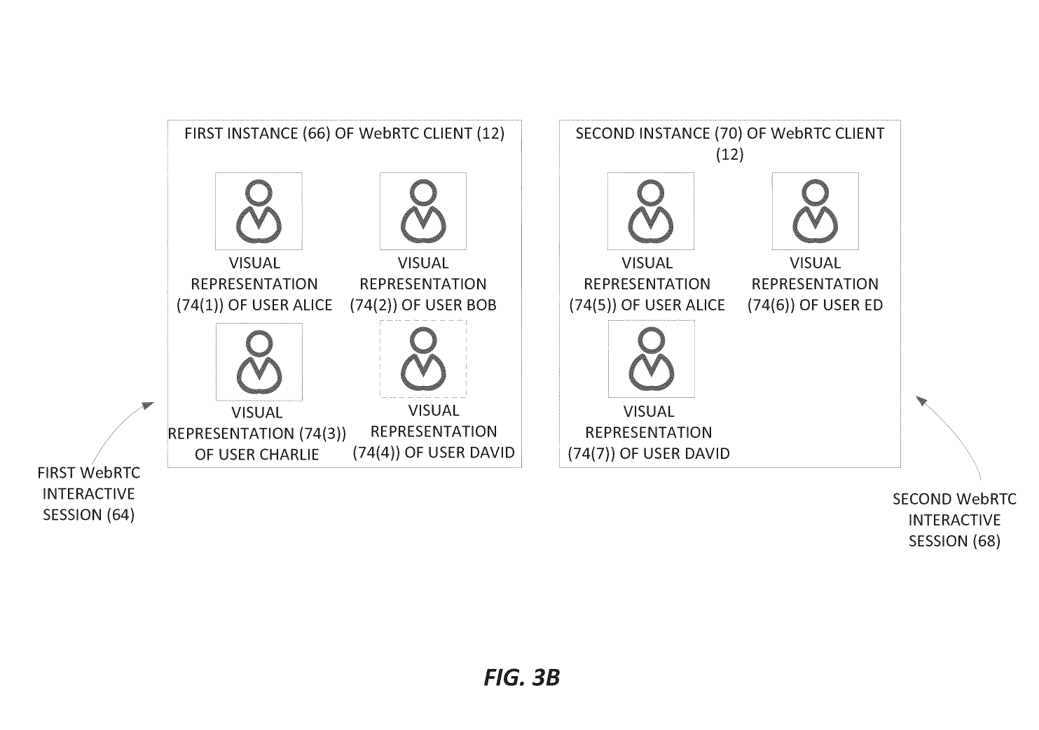

FIGS. 3A and 3B are diagrams illustrating a participant of a first WebRTC interactive session 64 in a first instance 66 of the WebRTC client 12 of FIG. 1 being added into an existing second WebRTC interactive session 68 in a second instance 70 of the WebRTC client 12 using a drag-and-drop user input gesture 72 according to embodiments disclosed herein. FIG. 3A illustrates the initial state of the first instance 66 and the second instance 70, while FIG. 3B illustrates the result of the drag-and-drop user input gesture 72. In FIGS. 3A and 3B, the first instance 66 and the second instance 70 of the WebRTC client 12 are shown as separate windows for the sake of clarity. It is to be understood, however, that some embodiments may provide that the first instance 66 and the second instance 70 may comprise separate browser tabs within a single application window, an empty browser tab created on demand, and/or may comprise other user interface configurations.

In FIG. 3A, the first instance 66 of the WebRTC client 12 displays the first WebRTC interactive session 64 including a visual representation 74(1) of user Alice, a visual representation 74(2) of user Bob, a visual representation 74(3) of user Charlie, and a visual representation 74(4) of a user David. Each visual representation 74 indicates one participant in the first WebRTC interactive session 64 between Alice, Bob, Charlie, and David occurring within the first instance 66 of the WebRTC client 12. Similarly, the second instance 70 of the WebRTC client 12 displays a visual representation 74(5) of user Alice and a visual representation 74(6) of user Ed, representing the second WebRTC interactive session 68 between Alice and Ed. In some embodiments, each visual representation 74 may be a dynamic representation such as a live video feed provided by a WebRTC real-time video flow, or a dynamically updated image or text string. Some embodiments, such as those in which the WebRTC interactive session includes only WebRTC audio or data flows, may provide that the visual representation of each participant may be a static image such as an icon or avatar image or static text string. According to some embodiments disclosed herein, the visual representations 74 may be arranged in rows and columns as seen in FIG. 3A, or the visual representations 74 may be arranged in other configurations (such as hiding or minimizing the visual representation of the user of the WebRTC client 12).

In the example of FIG. 3A, the WebRTC client 12 receives a user input gesture 72, which is directed to the visual representation 74(4) of user David. In some embodiments, the user input gesture 72 may comprise a drag-and-drop gesture initiated by clicking a mouse or other pointing device on the visual representation 74(4), or by touching the visual representation 74(4) on a touch screen. The visual representation 74(4) of user David is then dragged from the first instance 66 of the WebRTC client 12, and dropped on the second WebRTC interactive session 68 in the second instance 70 of the WebRTC client 12.

At this point, the WebRTC client 12 determines a current context 50. The context 50 includes an awareness of the current state and activities of the first instance 66 and the second instance 70 (i.e., an awareness that first and second WebRTC interactive sessions 64, 68 are currently active in the first instance 66 and the second instance 70, respectively). The WebRTC client 12 also obtains identity attributes 52 associated with the participants involved with the WebRTC interactive sessions in the first instance 66 and the second instance 70. The identity attributes 52 may include, for example, identity information used by the WebRTC client 12 in establishing the WebRTC interactive sessions.

Based on the user input gesture 72, the context 50, and the identity attributes 52, the WebRTC client 12 adds user David into the second WebRTC interactive session 68 in the second instance 70 of the WebRTC client 12. In some embodiments, this may be accomplished by the WebRTC client 12 establishing one or more new WebRTC interactive flows 42 between user David and the participants of the second WebRTC interactive session 68 in the second instance 70 with which user David is not already connected. The newly established WebRTC interactive flows 42 may be established between each user involved in the second WebRTC interactive session 68 (i.e., “full mesh” connections), and/or may be established between each user and a central media server such as the network element 48 of FIG. 1.

As seen in FIG. 3B, a visual representation 74(7) of user David is added to the second instance 70 of the WebRTC client 12, indicating that user David is now participating in a WebRTC interactive session with users Alice and Ed. In some embodiments, WebRTC interactive flows 42 between user David and the participants of the first WebRTC interactive session 64 in the first instance 66 of the WebRTC client 12 may be terminated, in which case the visual representation 74(4) of user David is removed from the first instance 66. Some embodiments may provide that one or more WebRTC interactive flows 42 between user David and the participants of the first WebRTC interactive session 64 in the first instance 66 may be modified to permit continued access by user David. For instance, a WebRTC audio flow between user David and the first WebRTC interactive session 64 in the first instance 66 may be maintained at a reduced volume or may be maintained with the audio muted by the WebRTC client 12. The visual representation 74(4) of user David provided to other participants may also be modified to indicate that user David is participating in another WebRTC interactive session. As non-limiting examples, the visual representation 74(4) of user David may be grayed or blurred out, or a WebRTC video flow from user David may be frozen or looped. According to some embodiments described herein, the handling of the WebRTC interactive flows between user David and the participants of the first WebRTC interactive session 64 may be automatically determined by defaults such as the defaults 54 of FIG. 1, and/or may be determined by the user input gesture 72.

In some embodiments, the WebRTC client 12 may detect whether the first instance 66 or the second instance 70 of the WebRTC client 12 has been designated as an active instance. For example, user Alice may have given focus to a window or tab in which the first instance 66 or the second instance 70 of the WebRTC client 12 is executing. In response, the WebRTC client 12 may provide a content of at least one of the one or more WebRTC interactive flows 42 associated with the active tab, and may suppress a content of at least one of the one or more WebRTC interactive flows 42 associated with the inactive tab. As non-limiting examples, WebRTC video, audio, and/or data flows from user Alice may be directed only to the second instance 70 and/or received from the second instance 70 when the second instance 70 is selected as the active instance, and otherwise may be hidden, muted, or maintained at a reduced volume by the WebRTC client 12 when the second instance 70 is not selected as the active instance

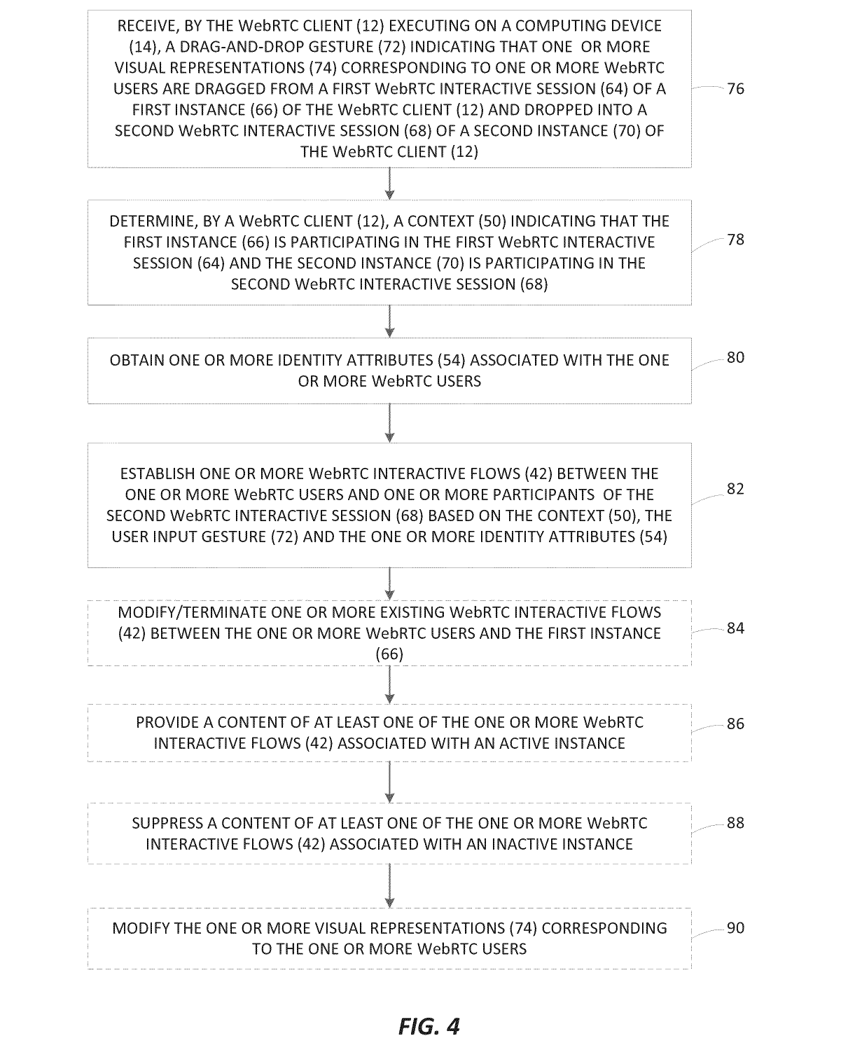

FIG. 4 is a flowchart illustrating exemplary operations for adding a participant of a WebRTC interactive session in a first instance of the WebRTC client of FIG. 1 into an existing WebRTC interactive session in a second instance of the WebRTC client using a drag-and-drop user input gesture, as discussed above with respect to FIGS. 3A and 3B. For the sake of clarity, elements of FIGS. 1 and 3A-3B are referenced in describing FIG. 4. In FIG. 4, operations begin with the WebRTC client 12 executing on the computing device 14 receiving a drag-and-drop user input gesture 72 (block 76) The user input gesture 72 indicates that one or more visual representations 74 corresponding to one or more WebRTC users are dragged from the first WebRTC interactive session 64 of the first instance 66 of the WebRTC client 12, and dropped into the second WebRTC interactive session 68 of the second instance 70 of the WebRTC client 12.

The WebRTC client 12 next determines a context 50 indicating that the first instance 66 is participating in the first WebRTC interactive session 64, and the second instance 70 is participating in the second WebRTC interactive session 68 (block 78). The WebRTC client 12 obtains one or more identity attributes 52 associated with the one or more WebRTC users corresponding to the one or more visual representations 74 (block 80). Based on the context 50, the user input gesture 72, and the one or more identity attributes 52, the WebRTC client 12 establishes one or more WebRTC interactive flows 42 between the one or more WebRTC users and one or more participants of the second WebRTC interactive session 68 (block 82).

In some embodiments, the WebRTC client 12 may subsequently modify and/or terminate one or more of the existing WebRTC interactive flows 42 between the one or more WebRTC users and the first instance 66 of the WebRTC client 12 (block 84). For example, the existing WebRTC interactive flows 42 between a user and the first instance 66 may be completely terminated to effectively transfer the user from the first WebRTC interactive session 64 to the second WebRTC interactive session 68. In some embodiments, the existing WebRTC interactive flows 42 may be modified rather than terminated (e.g., by providing audio only but no video for the first WebRTC interactive session 64). Some embodiments may provide that the WebRTC client 12 may reuse an existing WebRTC interactive flow 42 from the first WebRTC interactive session 64 to provide video, audio, and/or data flows to the second WebRTC interactive session 68. The WebRTC client 12 may also optionally provide a content of at least one of the one or more WebRTC interactive flows 42 associated with an active instance (e.g., the first instance 66 or the second instance 70 having the user focus) (block 86). The WebRTC client 12 may suppress a content of at least one of the one or more WebRTC interactive flows 42 associated with an inactive instance (e.g., the first instance 66 or the second instance 70 not having the user focus) (block 88).

The WebRTC client 12 may additionally modify the one or more visual representations 74 corresponding to the one or more WebRTC users (block 90). This may be used, for instance, to indicate that a WebRTC user participating in the second WebRTC interactive session 68 is not active in the first WebRTC interactive session 64. Modifying the one or more visual representations 74 may include highlighting, graying or blurring out a visual representation, or displaying a frozen or looping WebRTC video flow, as non-limiting examples.

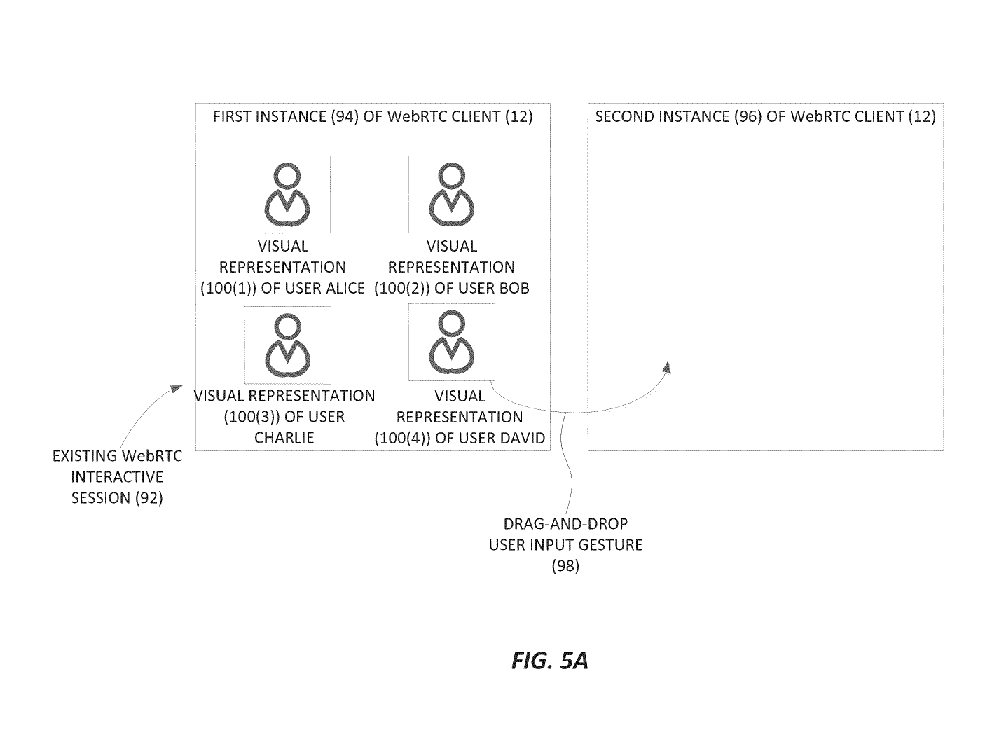

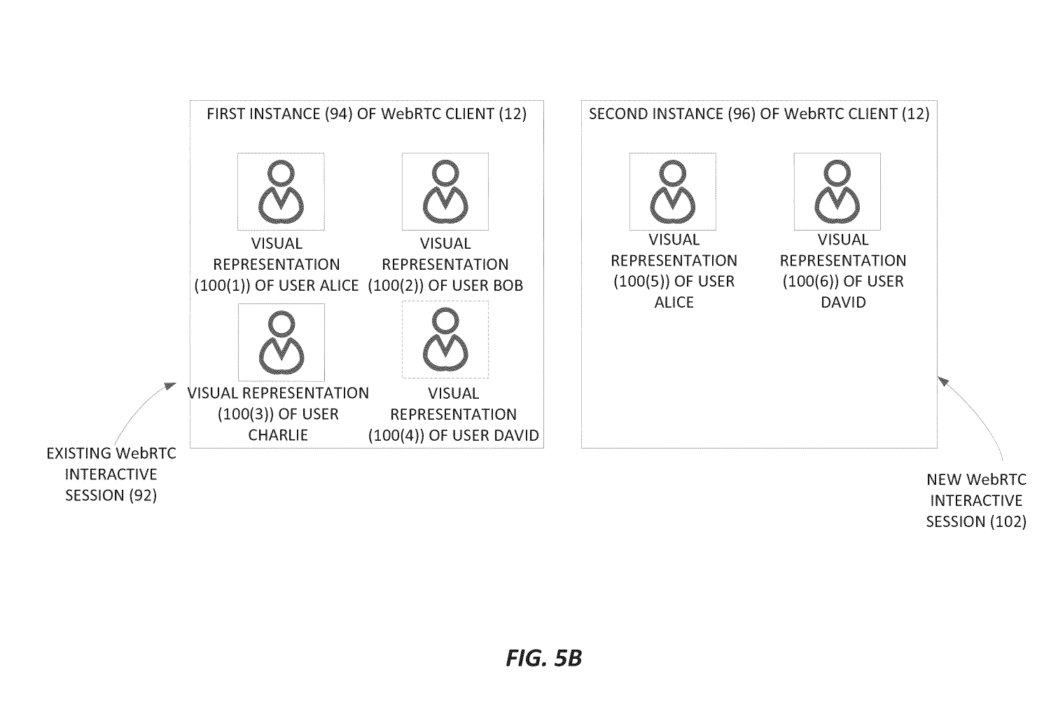

FIGS. 5A and 5B are diagrams illustrating a participant of an existing WebRTC interactive session 92 in a first instance 94 of the WebRTC client 12 of FIG. 1 being added into a new WebRTC interactive session in a second instance 96 of the WebRTC client 12 using a drag-and-drop user input gesture 98. In FIG. 5A, the initial state of the first instance 94 and the second instance 96 is illustrated, while FIG. 5B illustrates the result of the drag-and-drop user input gesture 98. While the first instance 94 and the second instance 96 of the WebRTC client 12 are shown as separate windows for the sake of clarity, it is to be understood that in some embodiments, the first instance 94 and the second instance 96 may comprise separate browser tabs within a single application window, an empty browser tab created on demand, and/or may comprise other user interface configurations.

In FIG. 5A, the first instance 94 of the WebRTC client 12 displays an existing WebRTC interactive session 92 including a visual representation 100(1) of user Alice, a visual representation 100(2) of user Bob, a visual representation 100(3) of user Charlie, and a visual representation 100(4) of a user David. Each visual representation 100 indicates one participant in the existing WebRTC interactive session 92 between Alice, Bob, Charlie, and David occurring within the first instance 94 of the WebRTC client 12. As noted above, each visual representation 100 may be a dynamic representation, such as a live video feed provided by a WebRTC real-time video flow, or may be a static image such as an icon or avatar image. The second instance 96 of the WebRTC client 12 contains no visual representations of users, indicating that there is no active WebRTC interactive session in progress.

In the example of FIG. 5A, the WebRTC client 12 receives a user input gesture 98, which is directed to the visual representation 100(4) of user David. As non-limiting examples, the user input gesture 98 may comprise a drag-and-drop gesture initiated by clicking a mouse or other pointing device on the visual representation 100(4), or by touching the visual representation 100(4) on a touch screen. The visual representation 100(4) of user David is then dragged from the first instance 94 of the WebRTC client 12, and dropped on the second instance 96 of the WebRTC client 12.

The WebRTC client 12 at this point determines a current context 50, including an awareness that a WebRTC interactive session is currently active in the first instance 94 but not in the second instance 96). The WebRTC client 12 also obtains identity attributes 52 associated with the participants involved with the WebRTC interactive sessions in the first instance 94. The identity attributes 52 may include, for example, identity information used by the WebRTC client 12 in establishing the WebRTC interactive sessions.

Based on the user input gesture 98, the context 50, and the identity attributes 52, the WebRTC client 12 creates a new WebRTC interactive session 102 in the second instance 96 of the WebRTC client 12, as seen in FIG. 5B. In some embodiments, this may be accomplished by the WebRTC client 12 establishing one or more WebRTC interactive flows 42 between user David and the user of the WebRTC client 12 who provided the user input gesture 98 (in this example, Alice). The established WebRTC interactive flows 42 may be established between each user involved in the new WebRTC interactive session 102 (i.e., “full mesh” connections), and/or may be established between each user and a central media server such as the network element 48 of FIG. 1. As seen in FIG. 5B, visual representations 100(5) and 100(6) of users Alice and David, respectively, are added to the second instance 96 of the WebRTC client 12, indicating that Alice and David are now participating in the new WebRTC interactive session 102. As discussed above, some embodiments may provide that WebRTC interactive flows between David and the participants of the WebRTC interactive session in the first instance 94 of the WebRTC client 12 may be terminated, or may be modified to indicate that user David is participating in another WebRTC interactive session.

Some embodiments may provide that the WebRTC client 12 may detect whether the first instance 94 or the second instance 96 of the WebRTC client 12 has been designated as an active instance. For example, user Alice may have given focus to a window or tab in which the first instance 94 or the second instance 96 of the WebRTC client 12 is executing. Accordingly, the WebRTC client 12 may provide a content of at least one of the one or more WebRTC interactive flows 42 associated with the active tab, and may suppress a content of at least one of the one or more WebRTC interactive flows 42 associated with the inactive tab. As non-limiting examples, WebRTC video, audio, and/or data flows from user Alice may be directed only to the second instance 96 and/or received from the second instance 96 when the second instance 96 is selected as the active instance.

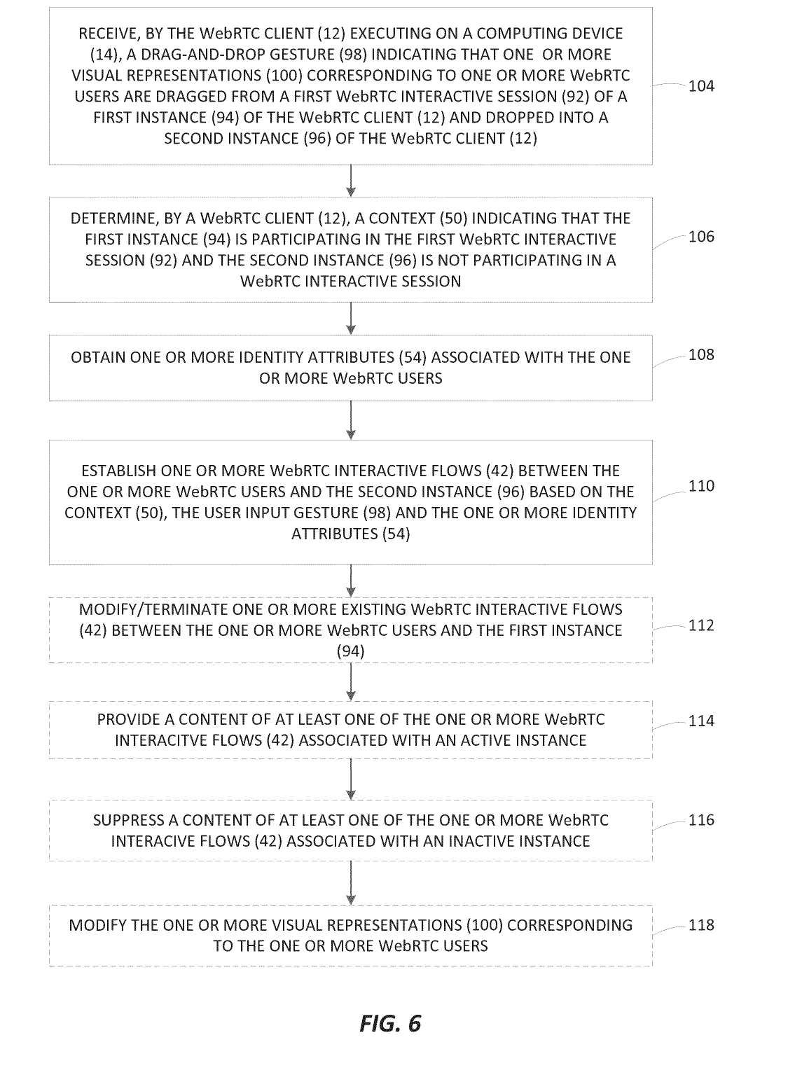

FIG. 6 is a flowchart illustrating exemplary operations for adding a participant of a WebRTC interactive session in a first instance of the WebRTC client of FIG. 1 into a new WebRTC interactive session in a second instance of the WebRTC client using a drag-and-drop user input gesture, as discussed above with respect to FIGS. 5A and 5B. For the sake of clarity, elements of FIGS. 1 and 5A-5B are referenced in describing FIG. 6. In FIG. 6, operations begin with the WebRTC client 12 executing on the computing device 14 receiving a drag-and-drop user input gesture 98 (block 104) The user input gesture 98 indicates that one or more visual representations 100 corresponding to one or more WebRTC users are dragged from an existing WebRTC interactive session 92 of a first instance 94 of the WebRTC client 12, and dropped into a second instance 96 of the WebRTC client 12.

The WebRTC client 12 next determines a context 50 indicating that the first instance 94 is participating in the first WebRTC interactive session 92, and the second instance 96 is not participating a WebRTC interactive session (block 106). The WebRTC client 12 obtains one or more identity attributes 52 associated with the one or more WebRTC users corresponding to the one or more visual representations 100 (block 108). Based on the context 50, the user input gesture 98, and the one or more identity attributes 52, the WebRTC client 12 establishes one or more WebRTC interactive flows 42 between the one or more WebRTC users and the second instance 96 of the WebRTC client 12 (block 110).

In some embodiments, the WebRTC client 12 may subsequently modify and/or terminate one or more of the existing WebRTC interactive flows 42 between the one or more WebRTC users and the first instance 94 of the WebRTC client 12 (block 112). For example, the existing WebRTC interactive flows 42 between a user and the first instance 94 may be completely terminated to effectively transfer the user from the existing WebRTC interactive session 92 to the new WebRTC interactive session 102. In some embodiments, the existing WebRTC interactive flows 42 may be modified rather than terminated (e.g., by providing audio only but no video for WebRTC interactive flows 42 for the existing WebRTC interactive session 92). The WebRTC client 12 may also optionally provide a content of at least one of the one or more WebRTC interactive flows 42 associated with an active instance (e.g., the first instance 94 or the second instance 96 having the user focus) (block 114). The WebRTC client 12 may suppress a content of at least one of the one or more WebRTC interactive flows 42 associated with an inactive instance (e.g., the first instance 94 or the second instance 96 not having the user focus) (block 116).

The WebRTC client 12 may additionally modify the one or more visual representations 100 corresponding to the one or more WebRTC users (block 118). This may be used, for instance, to indicate that a WebRTC user participating in the new WebRTC interactive session 102 is not active in the existing WebRTC interactive session 92. Modifying the one or more visual representations 100 may include highlighting, graying, or blurring out a visual representation, or displaying a frozen or looping WebRTC video flow.

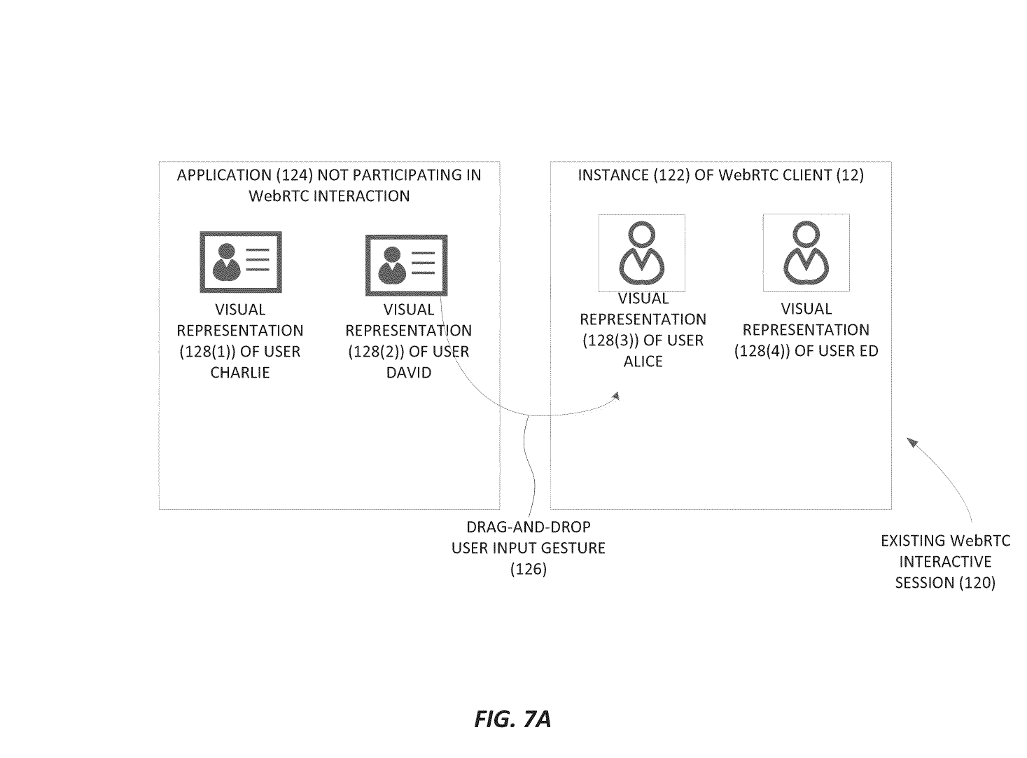

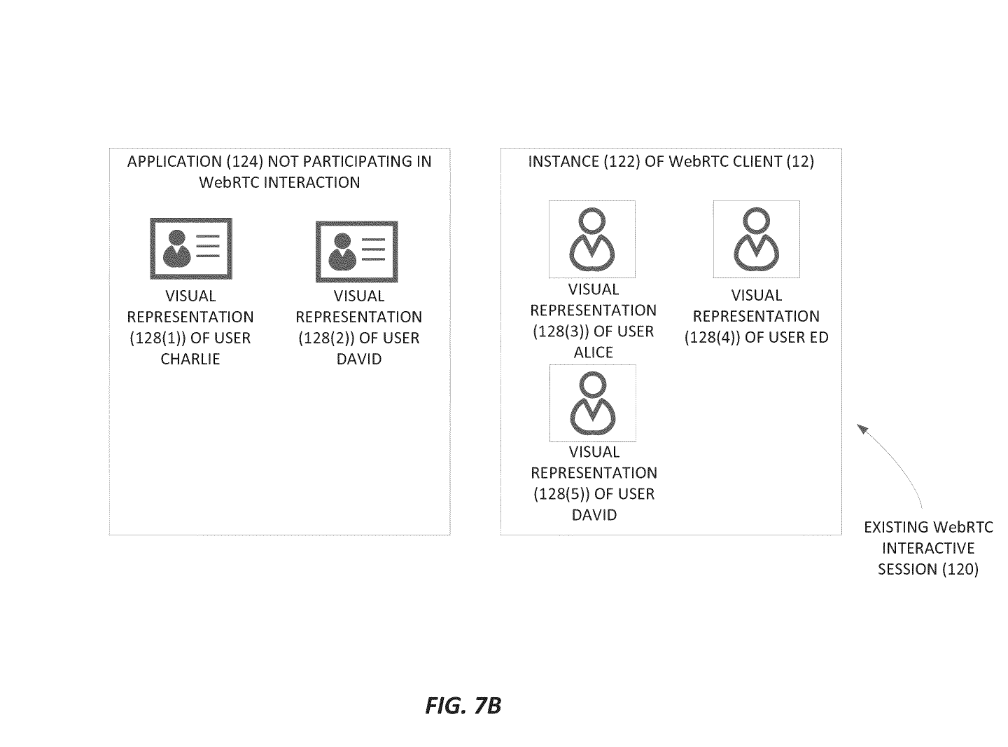

FIGS. 7A and 7B are diagrams illustrating a user being added to an existing WebRTC interactive session 120 in an instance 122 of the WebRTC client 12 of FIG. 1 using a visual representation of the user associated with an instance of an application 124 not participating in an active WebRTC exchange. The application 124 may include, as non-limiting examples, a non-WebRTC-enabled application or Web page, or may include an application providing notifications of incoming requests for WebRTC real-time communications. FIG. 7A illustrates the initial state of the application 124 and the instance 122 of the WebRTC client 12, while FIG. 7B illustrates the result of a drag-and-drop user input gesture 126. In FIGS. 7A and 7B, the instance 122 of the WebRTC client 12 is shown as a separate window for the sake of clarity. It is to be understood, however, that some embodiments may provide that the instance 122 may comprise a browser tab or other user interface configuration.

In FIG. 7A, the application 124 displays a visual representation 128(1) of user Charlie and a visual representation 128(2) of user David. Each of visual representation 128(1) and 128(2) indicates some form of identifying information for the corresponding user. For instance, the visual representations 128(1) and 128(2) may be web page icons linked to WebRTC contact information for Charlie and David, respectively, or may be text strings such as email addresses, as non-limiting examples. The instance 122 of the WebRTC client 12 displays a visual representation 128(3) of user Alice and a visual representation 128(4) of user Ed, representing the existing WebRTC interactive session 120 between Alice and Ed. In some embodiments, each visual representation 128(3) and 128(4) may be a dynamic representation, such as a live video feed provided by a WebRTC real-time video flow, or may be a static image such as an icon or avatar image. According to some embodiments disclosed herein, the visual representations 128(3) and 128(4) may be arranged as seen in FIG. 7A, or may be arranged in other configurations (such as hiding or minimizing the visual representation of the user of the WebRTC client 12).

In the example of FIG. 7A, the WebRTC client 12 receives the drag-and-drop user input gesture 126, which is directed to the visual representation 128(2) of user David. The user input gesture 126 may comprise a drag-and-drop gesture initiated by clicking a mouse or other pointing device on the visual representation 128(2), or by touching the visual representation 128(2) on a touch screen, as non-limiting examples. The visual representation 128(2) of user David is then dragged from the application 124, and dropped on the existing WebRTC interactive session 120 in the instance 122 of the WebRTC client 12.

At this point, the WebRTC client 12 determines a current context 50. The context 50 includes an awareness of the current state and activities of the instance 122. The WebRTC client 12 also obtains identity attributes 52 associated with the visual representation 128(2) and with participants in the WebRTC interactive session of the instance 122. The identity attributes 52 may include, for example, identity information provided by the application 124 that may be used by the WebRTC client 12 in establishing a WebRTC interactive session.

Based on the user input gesture 126, the context 50, and the identity attributes 52, the WebRTC client 12 adds user David into the existing WebRTC interactive session 120 in the instance 122 of the WebRTC client 12. In some embodiments, this may be accomplished by the WebRTC client 12 establishing one or more WebRTC interactive flows 42 between user David and the participants of the WebRTC interactive session in the instance 122. As seen in FIG. 7B, a visual representation 128(5) of user David is added to the instance 122 of the WebRTC client 12, indicating that user David is now participating in the existing WebRTC interactive session 120 with users Alice and Ed.

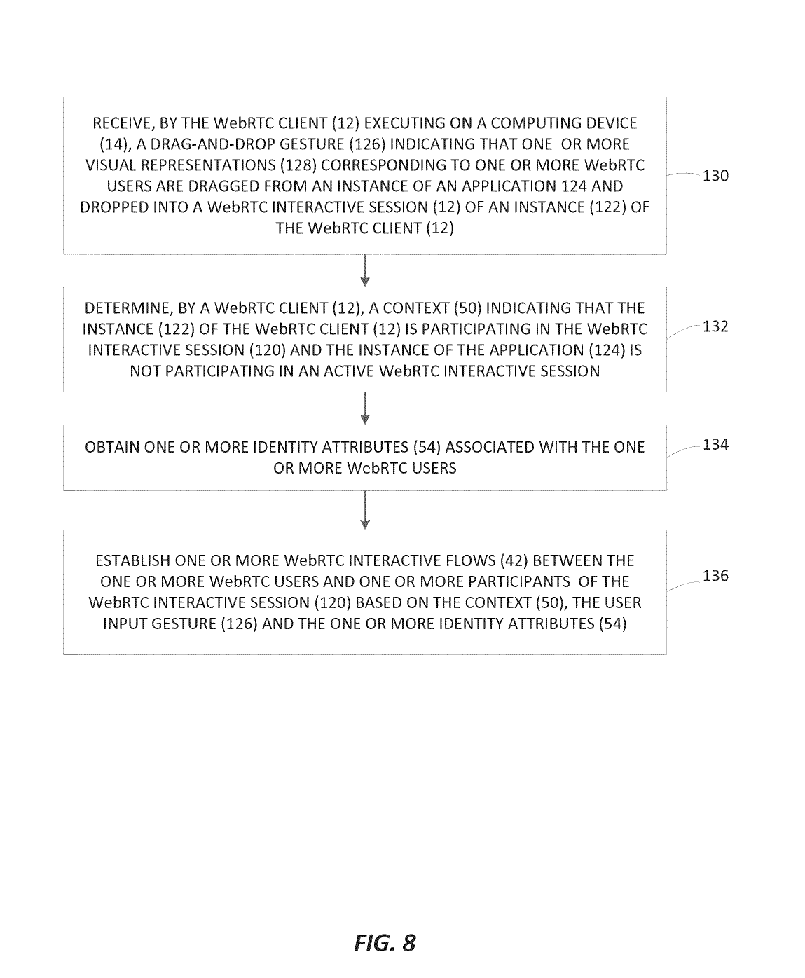

FIG. 8 is a flowchart illustrating exemplary operations for adding a user to a WebRTC interactive session in an instance of the WebRTC client of FIG. 1 using a visual representation of the user associated with an application not participating in a WebRTC exchange, as discussed above with respect to FIGS. 7A and 7B. For the sake of clarity, elements of FIGS. 1 and 7A-7B are referenced in describing FIG. 8. In FIG. 8, operations begin with the WebRTC client 12, executing on the computing device 14, receiving a drag-and-drop user input gesture 126 (block 130). The user input gesture 126 indicates that one or more visual representations 128 corresponding to one or more WebRTC users are dragged from an instance of an application 124 and dropped into an existing WebRTC interactive session 120 of an instance 122 of the WebRTC client 12.

The WebRTC client 12 determines a context 50 indicating that the instance 122 of the WebRTC client 12 is participating in the existing WebRTC interactive session 120, and that the instance of the application 124 is not participating in a WebRTC interactive session (block 132). The WebRTC client 12 obtains one or more identity attributes 52 associated with the one or more WebRTC users (block 134). Based on the context 50, the user input gesture 126, and the one or more identity attributes 52, the WebRTC client 12 then establishes one or more WebRTC interactive flows 42 between the one or more WebRTC users and one or more participants of the WebRTC interactive session 120 (block 136).

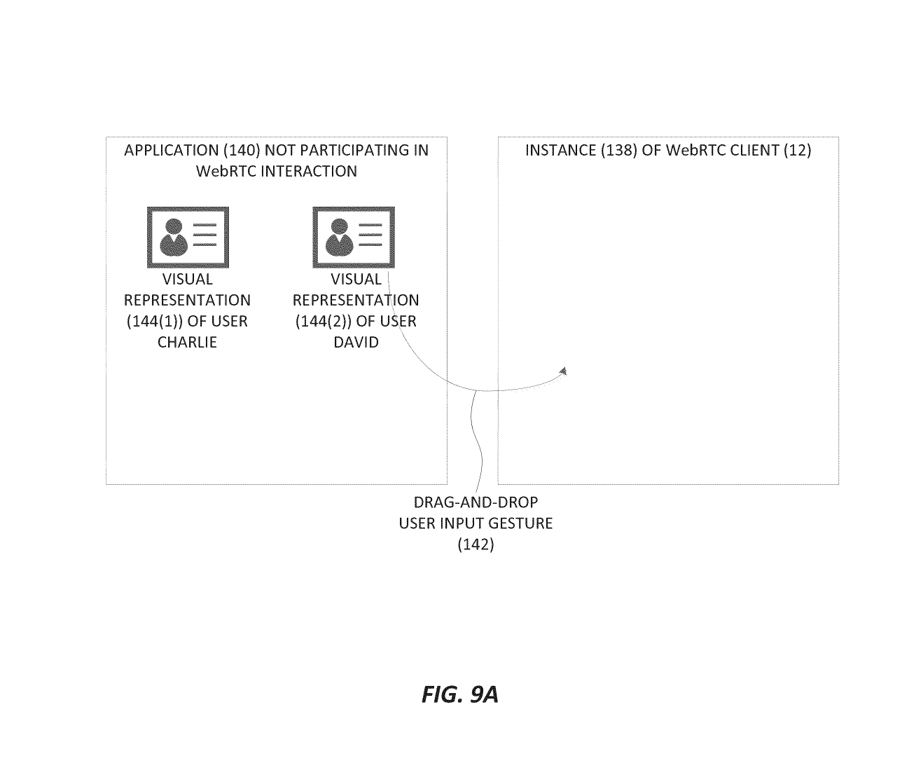

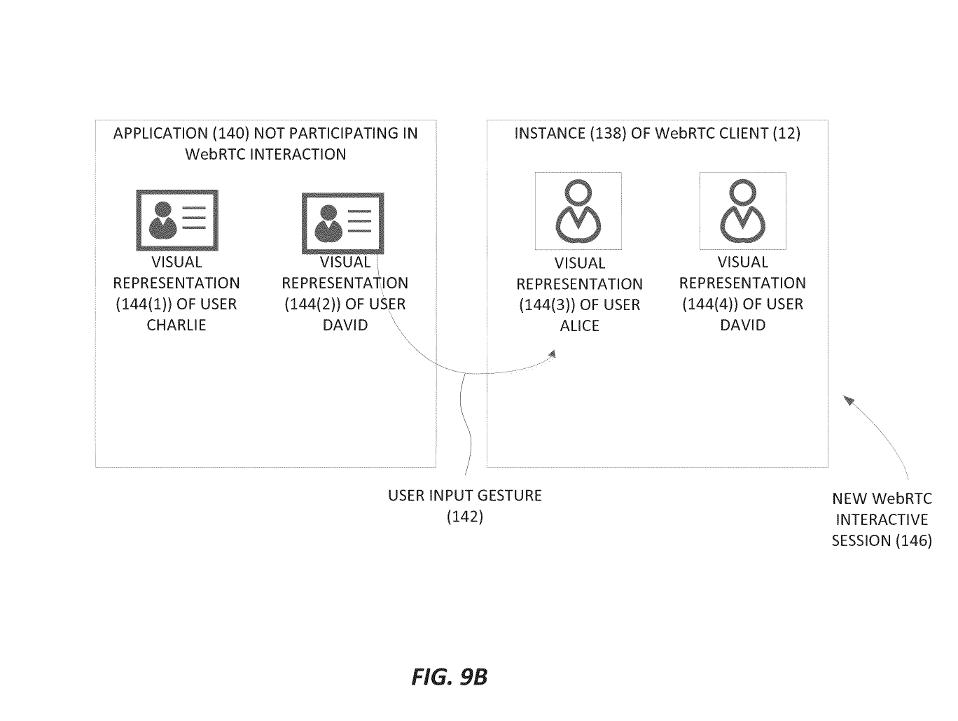

FIGS. 9A and 9B are diagrams illustrating a user being added to a new WebRTC interactive session in an instance 138 of the WebRTC client 12 of FIG. 1 using a visual representation of a user associated with an application 140 not participating in an active WebRTC exchange (such as a non-WebRTC-enabled application or Web page, or an application providing notifications of incoming requests for WebRTC real-time communications, as non-limiting examples). FIG. 9A illustrates the initial state of the application 140 and the instance 138 of the WebRTC client 12, while FIG. 9B illustrates the result of a drag-and-drop user input gesture 142. In FIGS. 9A and 9B, the instance 138 is shown as a separate window for the sake of clarity. It is to be understood, however, that some embodiments may provide that the instance 138 may comprise a browser tab or other user interface configuration.

In FIG. 9A, the application 140 displays a visual representation 144(1) of user Charlie and a visual representation 144(2) of user David, each indicating some form of identifying information for the corresponding user. For instance, the visual representations 144(1) and 144(2) may be web page icons linked to WebRTC contact information for Charlie and David, respectively, or may be text strings such as email addresses, as non-limiting examples. The instance 138 of the WebRTC client 12 does not display any visual representations of users, indicating that a WebRTC interactive session is not currently taking place.

In the example of FIG. 9A, the WebRTC client 12 receives the drag-and-drop user input gesture 142, which is directed to the visual representation 144(2) of user David. In some embodiments, the user input gesture 142 may comprise a drag-and-drop gesture initiated by clicking a mouse or other pointing device on the visual representation 144(2), or by touching the visual representation 144(2) on a touch screen, as non-limiting examples. The visual representation 144(2) of user David is then dragged from the application 140, and dropped on the instance 138 of the WebRTC client 12.

The WebRTC client 12 then determines a current context 50, including an awareness of the current state and activities of the instance 138. The WebRTC client 12 also obtains identity attributes 52 associated with the visual representation 144(2). The identity attributes 52 may include, for example, identity information provided by the application 140 that may be used by the WebRTC client 12 in establishing a WebRTC interactive session.

Based on the user input gesture 142, the context 50, and the identity attributes 52, the WebRTC client 12 creates a new WebRTC interactive session 146 in the instance 138 of the WebRTC client 12. In some embodiments, this may be accomplished by the WebRTC client 12 establishing one or more WebRTC interactive flows 42 between user David and the user of the WebRTC client 12 (in this example, user Alice). As seen in FIG. 9B, a visual representation 144(3) of user Alice and a visual representation 144(4) of user David is added to the instance 138 of the WebRTC client 12, indicating that user David is now participating in the new WebRTC interactive session 146 with user Alice.

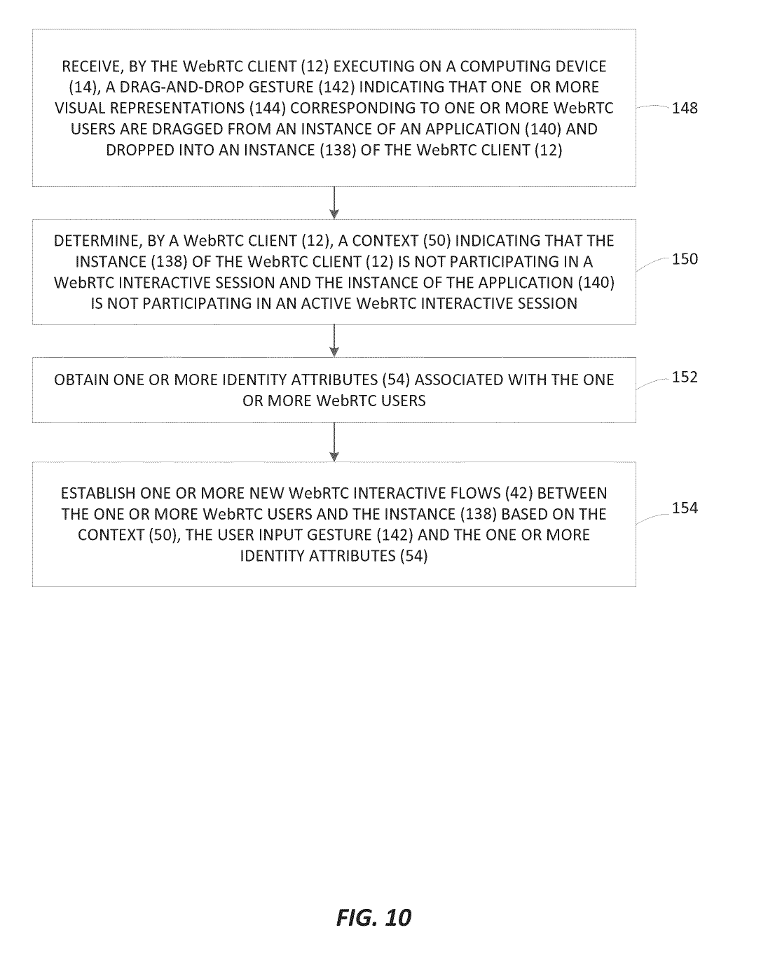

FIG. 10 is a flowchart illustrating exemplary operations for adding a user to a new WebRTC interactive session in an instance of the WebRTC client of FIG. 1 using a visual representation of a user associated with an application not participating in a WebRTC exchange, as discussed above with respect to FIGS. 9A and 9B. For the sake of clarity, elements of FIGS. 1 and 9A-9B are referenced in describing FIG. 10. In FIG. 10, operations begin with the WebRTC client 12, executing on the computing device 14, receiving a drag-and-drop user input gesture 142 (block 148). The user input gesture 142 indicates that one or more visual representations 144 corresponding to one or more WebRTC users are dragged from an instance of an application 140 and dropped into an instance 138 of the WebRTC client 12.

The WebRTC client 12 determines a context 50 indicating that the instance 138 of the WebRTC client 12 is not participating in a WebRTC interactive session, and that the instance of the application 140 is not participating in a WebRTC interactive session (block 150). The WebRTC client 12 obtains one or more identity attributes 52 associated with the one or more WebRTC users (block 152). Based on the context 50, the user input gesture 142, and the one or more identity attributes 52, the WebRTC client 12 then establishes one or more new WebRTC interactive flows 42 between the one or more WebRTC users and the instance 138 of the WebRTC client 12 (block 154).

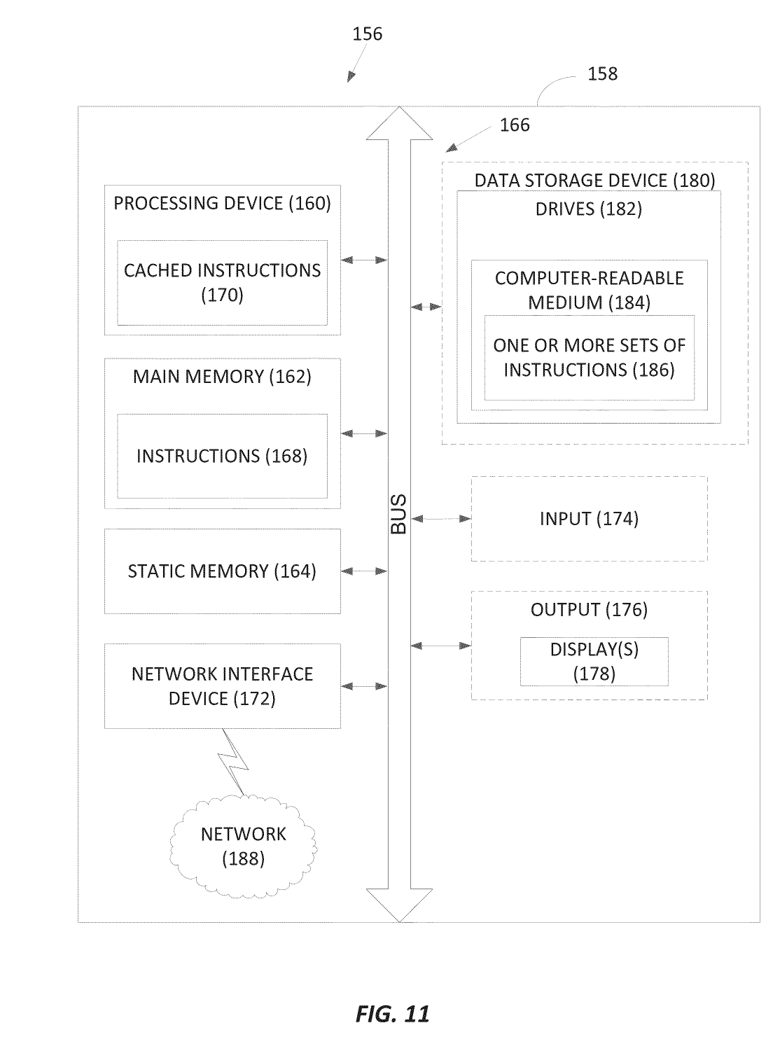

FIG. 11 provides a block diagram representation of a processing system 156 in the exemplary form of an exemplary computer system 158 adapted to execute instructions to perform the functions described herein. In some embodiments, the processing system 156 may execute instructions to perform the functions of the WebRTC client 12 of FIG. 1. In this regard, the processing system 156 may comprise the computer system 158, within which a set of instructions for causing the processing system 156 to perform any one or more of the methodologies discussed herein may be executed. The processing system 156 may be connected (as a non-limiting example, networked) to other machines in a local area network (LAN), an intranet, an extranet, or the Internet. The processing system 156 may operate in a client-server network environment, or as a peer machine in a peer-to-peer (or distributed) network environment. While only a single processing system 156 is illustrated, the terms “controller” and “server” shall also be taken to include any collection of machines that individually or jointly execute a set (or multiple sets) of instructions to perform any one or more of the methodologies discussed herein. The processing system 156 may be a server, a personal computer, a desktop computer, a laptop computer, a personal digital assistant (PDA), a computing pad, a mobile device, or any other device and may represent, as non-limiting examples, a server or a user's computer.

The exemplary computer system 158 includes a processing device or processor 160, a main memory 162 (as non-limiting examples, read-only memory (ROM), flash memory, dynamic random access memory (DRAM) such as synchronous DRAM (SDRAM), etc.), and a static memory 164 (as non-limiting examples, flash memory, static random access memory (SRAM), etc.), which may communicate with each other via a bus 166. Alternatively, the processing device 160 may be connected to the main memory 162 and/or the static memory 164 directly or via some other connectivity means.

The processing device 160 represents one or more processing devices such as a microprocessor, central processing unit (CPU), or the like. More particularly, the processing device 160 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 160 is configured to execute processing logic in instructions 168 and/or cached instructions 170 for performing the operations and steps discussed herein.

The computer system 158 may further include a communications interface in the form of a network interface device 172. It also may or may not include an input 174 to receive input and selections to be communicated to the computer system 158 when executing the instructions 168, 170. It also may or may not include an output 176, including but not limited to display(s) 178. The display(s) 178 may be a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 158 may or may not include a data storage device 180 that includes using drive(s) 182 to store the functions described herein in a computer-readable medium 184, on which is stored one or more sets of instructions 186 (e.g., software) embodying any one or more of the methodologies or functions described herein. The functions can include the methods and/or other functions of the processing system 156, a participant user device, and/or a licensing server, as non-limiting examples. The one or more sets of instructions 186 may also reside, completely or at least partially, within the main memory 162 and/or within the processing device 160 during execution thereof by the computer system 158. The main memory 162 and the processing device 160 also constitute machine-accessible storage media. The instructions 168, 170, and/or 186 may further be transmitted or received over a network 188 via the network interface device 172. The network 188 may be an intra-network or an inter-network.

While the computer-readable medium 184 is shown in an exemplary embodiment to be a single medium, the term “machine-accessible storage medium” should be taken to include a single medium or multiple media (as non-limiting examples, a centralized or distributed database, and/or associated caches and servers) that store the one or more sets of instructions 186. The term “machine-accessible storage medium” shall also be taken to include any medium that is capable of storing, encoding, or carrying a set of instructions for execution by the machine, and that cause the machine to perform any one or more of the methodologies disclosed herein. The term “machine-accessible storage medium” shall accordingly be taken to include, but not be limited to, solid-state memories, optical and magnetic media, and carrier wave signals.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A system for intelligently managing Web Real-Time Communications (WebRTC) interactive flows, comprising:
at least one communications interface;
a computing device associated with the at least one communications interface, the computing device comprising a WebRTC client configured to:
receive a user input gesture directed to one or more visual representations corresponding to one or more WebRTC users;
determine a context for the WebRTC client based on a current state of the WebRTC client;
obtain one or more identity attributes associated with the one or more WebRTC users; and
provide one or more WebRTC interactive flows including the one or more WebRTC users based on the context, the user input gesture, and the one or more identity attributes.

2. The system of claim 1, wherein the WebRTC client is further configured to provide the one or more WebRTC interactive flows based on one or more established administrative defaults.

3. The system of claim 1, wherein the WebRTC client is configured to receive the user input gesture by receiving a user input gesture for initiating a pop-up menu of user-selectable options;
the WebRTC client further configured to present the pop-up menu responsive to the user input gesture.

4. The system of claim 1, wherein the WebRTC client is configured to receive the user input gesture by receiving a drag-and-drop gesture indicating that the one or more visual representations corresponding to the one or more WebRTC users are dragged from a first WebRTC interactive session of a first instance of the WebRTC client and dropped into a second WebRTC interactive session of a second instance of the WebRTC client;
wherein the WebRTC client is configured to determine the context for the WebRTC client by determining that the first instance of the WebRTC client is participating in the first WebRTC interactive session, and the second instance of the WebRTC client is participating in the second WebRTC interactive session; and
wherein the WebRTC client is configured to provide the one or more WebRTC interactive flows including the one or more WebRTC users by establishing the one or more WebRTC interactive flows between the one or more WebRTC users and one or more participants of the second WebRTC interactive session.

5. The system of claim 4, wherein the WebRTC client is further configured to:
responsive to one of the first instance of the WebRTC client and the second instance of the WebRTC client being designated as an active instance, provide a content of at least one of the one or more WebRTC interactive flows associated with the active instance; and
responsive to one of the first instance of the WebRTC client and the second instance of the WebRTC client being designated as an inactive instance, suppress a content of at least one of the one or more WebRTC interactive flows associated with the inactive instance.

6. The system of claim 4, wherein the WebRTC client is further configured to modify the one or more visual representations corresponding to the one or more WebRTC users in the WebRTC interactive session of the first instance of the WebRTC client to indicate that the one or more WebRTC users are not active in the WebRTC interactive session of the first instance of the WebRTC client.

7. The system of claim 6, wherein the WebRTC client is configured to modify the one or more visual representations corresponding to the one or more WebRTC users by highlighting the one or more visual representations, graying out the one or more visual representations, blurring the one or more visual representations, providing a WebRTC video flow while muting a WebRTC audio flow, freezing a WebRTC video flow, or looping a portion of a WebRTC video flow, or combinations thereof.

8. The system of claim 4, wherein the WebRTC client is further configured to terminate one or more existing WebRTC interactive flows between the one or more WebRTC users and the first instance of the WebRTC client.

9. The system of claim 4, wherein the WebRTC client is further configured to modify one or more existing WebRTC interactive flows between the one or more WebRTC users and the first instance of the WebRTC client.

10. The system of claim 1, wherein the WebRTC client is configured to receive the user input gesture by receiving a drag-and-drop gesture indicating that the one or more visual representations corresponding to the one or more WebRTC users are dragged from a WebRTC interactive session of a first instance of the WebRTC client and dropped into a second instance of the WebRTC client;
wherein the WebRTC client is configured to determine the context for the WebRTC client by determining that the first instance of the WebRTC client is participating in the WebRTC interactive session, and the second instance of the WebRTC client is not participating in the WebRTC interactive session; and
wherein the WebRTC client is configured to provide the one or more WebRTC interactive flows including the one or more WebRTC users by establishing the one or more WebRTC interactive flows between the one or more WebRTC users and the second instance of the WebRTC client.

11. The system of claim 10, wherein the WebRTC client is further configured to:
responsive to one of the first instance of the WebRTC client and the second instance of the WebRTC client being designated as an active instance, provide a content of at least one of the one or more WebRTC interactive flows associated with the active instance; and
responsive to one of the first instance of the WebRTC client and the second instance of the WebRTC client being designated as an inactive instance, suppress a content of at least one of the one or more WebRTC interactive flows associated with the inactive instance.

12. The system of claim 10, wherein the WebRTC client is further configured to modify the one or more visual representations corresponding to the one or more WebRTC users in the WebRTC interactive session of the first instance of the WebRTC client to indicate that the one or more WebRTC users are participating in a second WebRTC interactive session of the second instance of the WebRTC client.

13. The system of claim 12, wherein the WebRTC client is configured to modify the one or more visual representations corresponding to the one or more WebRTC users by graying out the one or more visual representations, blurring the one or more visual representations, providing a WebRTC video flow while muting a WebRTC audio flow, freezing a WebRTC video flow, or looping a portion of a WebRTC video flow, or combinations thereof.

14. The system of claim 10, wherein the WebRTC client is further configured to terminate one or more WebRTC interactive flows between the one or more WebRTC users and the first instance of the WebRTC client.

15. The system of claim 10, wherein the WebRTC client is further configured to modify one or more WebRTC interactive flows between the one or more WebRTC users and the first instance of the WebRTC client.

16. The system of claim 1, wherein the WebRTC client is configured to receive the user input gesture by receiving a drag-and-drop gesture indicating that the one or more visual representations corresponding to the one or more WebRTC users are dragged from an instance of an application and dropped into a WebRTC interactive session of an instance of the WebRTC client;
wherein the WebRTC client is configured to determine the context for the WebRTC client by determining that the instance of the WebRTC client is participating in the WebRTC interactive session, and the instance of the application is not participating in an active WebRTC interactive session; and
wherein the WebRTC client is configured to provide the one or more WebRTC interactive flows including the one or more WebRTC users by establishing one or more new WebRTC interactive flows between the one or more WebRTC users and one or more participants of the WebRTC interactive session.

17. The system of claim 1, wherein the WebRTC client is configured to receive the user input gesture by receiving a drag-and-drop gesture indicating that the one or more visual representations corresponding to the one or more WebRTC users are dragged from an instance of an application and dropped into an instance of the WebRTC client;
wherein the WebRTC client is configured to determine the context for the WebRTC client by determining that the instance of the WebRTC client is not participating in a WebRTC interactive session, and the instance of the application is not participating in an active WebRTC interactive session; and
wherein the WebRTC client is configured to provide the one or more WebRTC interactive flows including the one or more WebRTC users by establishing one or more new WebRTC interactive flows between the one or more WebRTC users and the instance of the WebRTC client.

18. A method for intelligently managing Web Real-Time Communications (WebRTC) interactive flows, comprising:
receiving, by a WebRTC client executing on a computing device, a user input gesture directed to one or more visual representations corresponding to one or more WebRTC users;
determining, by the WebRTC client, a context for the WebRTC client based on a current state of the WebRTC client;
obtaining one or more identity attributes associated with the one or more WebRTC users; and
providing one or more WebRTC interactive flows including the one or more WebRTC users based on the context, the user input gesture, and the one or more identity attributes.

19. The method of claim 18, wherein receiving the user input gesture comprises receiving a drag-and-drop gesture indicating that the one or more visual representations corresponding to the one or more WebRTC users are dragged from a first WebRTC interactive session of a first instance of the WebRTC client and dropped into a second WebRTC interactive session of a second instance of the WebRTC client;
wherein determining the context for the WebRTC client comprises determining that the first instance of the WebRTC client is participating in the first WebRTC interactive session, and the second instance of the WebRTC client is participating in the second WebRTC interactive session; and
wherein providing the one or more WebRTC interactive flows including the one or more WebRTC users comprises establishing the one or more WebRTC interactive flows between the one or more WebRTC users and one or more participants of the second WebRTC interactive session.

20. The method of claim 18, wherein receiving the user input gesture comprises receiving a drag-and-drop gesture indicating that the one or more visual representations corresponding to the one or more WebRTC users are dragged from a WebRTC interactive session of a first instance of the WebRTC client and dropped into a second instance of the WebRTC client;
wherein determining the context for the WebRTC client comprises determining that the first instance of the WebRTC client is participating in the WebRTC interactive session, and the second instance of the WebRTC client is not participating in a WebRTC interactive session; and
wherein providing the one or more WebRTC interactive flows including the one or more WebRTC users comprises establishing the one or more WebRTC interactive flows between the one or more WebRTC users and the second instance of the WebRTC client.

21. The method of claim 18, wherein receiving the user input gesture comprises receiving a drag-and-drop gesture indicating that the one or more visual representations corresponding to the one or more WebRTC users are dragged from an instance of an application and dropped into a WebRTC interactive session of an instance of the WebRTC client; and
wherein determining the context for the WebRTC client comprises determining that the instance of the WebRTC client is participating in the WebRTC interactive session, and the instance of the application is not participating in an active WebRTC interactive session; and
wherein providing the one or more WebRTC interactive flows including the one or more WebRTC users comprises establishing one or more new WebRTC interactive flows between the one or more WebRTC users and one or more participants of the WebRTC interactive session.

22. The method of claim 18, wherein receiving the user input gesture comprises receiving a drag-and-drop gesture indicating that the one or more visual representations corresponding to the one or more WebRTC users are dragged from an instance of an application and dropped into an instance of the WebRTC client;
wherein determining the context for the WebRTC client comprises determining that the instance of the WebRTC client is not participating in a WebRTC interactive session, and the instance of the application is not participating in an active WebRTC interactive session; and
wherein providing the one or more WebRTC interactive flows including the one or more WebRTC users comprises establishing one or more new WebRTC interactive flows between the one or more WebRTC users and the instance of the WebRTC client.

23. A non-transitory computer-readable medium having stored thereon computer-executable instructions to cause a processor to implement a method for intelligently managing Web Real-Time Communications (WebRTC) interactive flows, comprising:
receiving a user input gesture directed to one or more visual representations corresponding to one or more WebRTC users;
determining a context for a WebRTC client based on a current state of the WebRTC client;
obtaining one or more identity attributes associated with the one or more WebRTC users; and
providing one or more WebRTC interactive flows including the one or more WebRTC users based on the context, the user input gesture, and the one or more identity attributes.

24. The non-transitory computer-readable medium of claim 23 having stored thereon the computer-executable instructions to cause the processor to implement the method, wherein receiving the user input gesture comprises receiving a drag-and-drop gesture indicating that the one or more visual representations corresponding to the one or more WebRTC users are dragged from a first WebRTC interactive session of a first instance of the WebRTC client and dropped into a second WebRTC interactive session of a second instance of the WebRTC client;
wherein determining the context for the WebRTC client comprises determining that the first instance of the WebRTC client is participating in the first WebRTC interactive session, and the second instance of the WebRTC client is participating in the second WebRTC interactive session; and
wherein providing the one or more WebRTC interactive flows including the one or more WebRTC users comprises establishing the one or more WebRTC interactive flows between the one or more WebRTC users and one or more participants of the second WebRTC interactive session.

25. The non-transitory computer-readable medium of claim 23 having stored thereon the computer-executable instructions to cause the processor to implement the method, wherein receiving the user input gesture comprises receiving a drag-and-drop gesture indicating that the one or more visual representations corresponding to the one or more WebRTC users are dragged from a WebRTC interactive session of a first instance of the WebRTC client and dropped into a second instance of the WebRTC client;
wherein determining the context for the WebRTC client comprises determining that the first instance of the WebRTC client is participating in the WebRTC interactive session, and the second instance of the WebRTC client is not participating in a WebRTC interactive session; and
wherein providing the one or more WebRTC interactive flows including the one or more WebRTC users comprises establishing the one or more WebRTC interactive flows between the one or more WebRTC users and the second instance of the WebRTC client.

26. The non-transitory computer-readable medium of claim 23 having stored thereon the computer-executable instructions to cause the processor to implement the method, wherein receiving the user input gesture comprises receiving a drag-and-drop gesture indicating that the one or more visual representations corresponding to the one or more WebRTC users are dragged from an instance of an application and dropped into a WebRTC interactive session of an instance of the WebRTC client; and
wherein determining the context for the WebRTC client comprises determining that the instance of the WebRTC client is participating in the WebRTC interactive session, and the instance of the application is not participating in an active WebRTC interactive session; and
wherein providing the one or more WebRTC interactive flows including the one or more WebRTC users comprises establishing one or more new WebRTC interactive flows between the one or more WebRTC users and one or more participants of the WebRTC interactive session.

27. The non-transitory computer-readable medium of claim 23 having stored thereon the computer-executable instructions to cause the processor to implement the method, wherein receiving the user input gesture comprises receiving a drag-and-drop gesture indicating that the one or more visual representations corresponding to the one or more WebRTC users are dragged from an instance of an application and dropped into an instance of the WebRTC client;
wherein determining the context for the WebRTC client comprises determining that the instance of the WebRTC client is not participating in a WebRTC interactive session, and the instance of the application is not participating in an active WebRTC interactive session; and
wherein providing the one or more WebRTC interactive flows including the one or more WebRTC users comprises establishing one or more new WebRTC interactive flows between the one or more WebRTC users and the instance of the WebRTC client.
